(19) United States
(12) Patent Application Publication
(10) Pub. No.: US 2002/0057250 A1
(43) Pub. Date: May 16, 2002

(54) Methods and apparatus for imaging electronic paper

(76) Inventor: A. John Michaelis, Balmain (AU)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/933,320

(22) Filed: Aug. 20, 2001

Related U.S. Application Data
(60) Provisional application No. 60/226,736, filed on Aug. 21, 2000.

(51) Int. Cl. G09G 3/36

(52) U.S. Cl. 345/96

(57) ABSTRACT

A system for imaging electronic paper is disclosed. The system places a photoconductive layer into the electronic paper. For example, a layer of selenium, cadmium sulfide, photoconductive silicon, or any organic photoconductor (OPC) may be used in the photoconductive layer. The entire electronic paper is exposed to the same electrical potential (not selectively in a grid), but the electrostatic display cells are insulated from the electrical potential by the photoconductive layer. The photoconductive layer is then selectively illuminated by a focused light source (e.g., a scanning laser beam), thereby exposing selected electrostatic display cells to the electrical potential and writing an image to the electronic paper. In this manner, electronic paper may be imaged using existing high-resolution laser printing mechanisms.

### RELATED APPLICATION

This application claims priority from U.S. Provisional Application Serial No. 60/226,736 filed Aug. 21, 2000, and which is hereby incorporated herein by reference.

### TECHNICAL FIELD

The present system relates in general to imaging systems, and, in particular, to methods and apparatus for imaging electronic paper.

### BACKGROUND

Many developers such as e-Ink are creating electronic paper. Electronic paper is a display system that offers image retention without electrical power, or with minimal power requirements. Typically, these systems require an electrostatic field to be selectively applied to a visual switching element (i.e., an electrostatic display cell) for a time period long enough to effect a change in the visual display. Normally, a conductive backplane electrode is placed behind one or more electrostatic display cells, and a second transparent conductive front plane electrode is placed in front of the electrostatic display cells. Applying sufficient potential between the electrodes will provide sufficient electrostatic field to switch the adjacent display cells to one mode (e.g., black). Reversing the electrode polarity of the back and front planes switches the display cells to a second mode (e.g., white).

An electrode grid with individually addressable cells may be used to provide an electrostatic field in selected areas of the electronic paper. Alternatively, a single electrode pair may be scanned across the electronic paper as the paper is advanced in a manner similar to a conventional printer. The display remains in the switched state for a period even after the electrostatic field is removed, or until applying a new electrostatic field changes the information.

There are a variety of existing methods used to produce electronic paper. For example, one system disclosed by e-Ink uses translucent enclosures that contain a fluid and an electrically charged material. The electrically charged material migrates to the front or back of the cell according to the electrostatic field across the cell. When the electrically charged material is in the front of the cell, it is visible. When the electrically charged material is in the rear of the cell, it is not visible. If the materials are of different hues or color densities, then a visual pattern can be produced.

Another system under development by Xerox makes use of many tiny spheres that have one color on the front of the sphere, and another color on the back of the sphere. The spheres are electrostatically charged, with a charge of one polarity on the front and another polarity on the back. Each of these charged spheres is captured in a translucent spherical cell or bubble in such a way that the spheres can rotate freely within the cell. When the cells containing bubbles are in an electric field of appropriate strength, the spheres rotate so that either the front or the rear of the sphere is in view.

### BRIEF DESCRIPTION OF THE DRAWINGS

Features and advantages of the disclosed methods and apparatus will be apparent to those of ordinary skill in the art in view of the detailed description of exemplary embodiments which is made with reference to the drawings, a brief description of which is provided below.

FIG. 1 is a block diagram illustrating one arrangement for writing an image to electrostatic display cells.

FIG. 2 is a block diagram illustrating another arrangement for writing an image to electrostatic display cells.

FIG. 3 is a block diagram of a computing device suitable for controlling a writing operation to electrostatic display cells.

### DETAILED DESCRIPTION OF EXEMPLARY EMBODIMENTS

In general, a system for addressing electronic paper is disclosed. The system places a photoconductive layer into the electronic paper. For example, a layer of selenium, cadmium sulfide, photoconductive silicon, or any organic photoconductor (OPC) may be used in the photoconductive layer. The entire electronic paper is exposed to the same electrical potential (not selectively in a grid), but the electrostatic display cells are insulated from the electrical potential by the photoconductive layer. The photoconductive layer is then selectively illuminated by a focused light source (e.g., a scanning laser beam), thereby exposing selected electrostatic display cells to the electrical potential and writing an image to the electronic paper. In this manner, electronic paper may be imaged using existing high resolution laser printing mechanisms, including motors to advance the laser across the electronic paper dot-by-dot and motors to advance the electronic paper forward line-by-line.

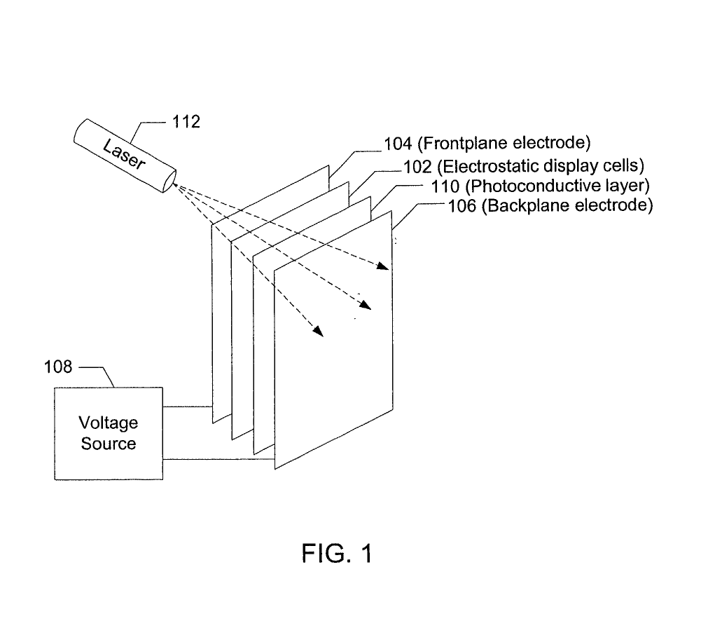

A block diagram illustrating one arrangement for writing an image to electrostatic display cells is illustrated in FIG. 1. In this embodiment, the electrostatic display cells 102 are placed between a front plane electrode 104 and a back plane electrode 106. A voltage source 108 is connected between the entire front plane electrode 104 and, the entire back plane electrode 106.

In order to address the electrostatic display cells 102 at the desired resolution, a photoconductive layer 110 and a light source 112, such as a laser, are used. If the photoconductive layer 110 were not present, applying one electrical potential (e.g., positive) between the front plane electrode 104 and the back plane electrode 106 would “erase” all of the electrostatic display cells 102 (i.e., all of the cells would take on a first state). Similarly, if the photoconductive layer 110 were not present, applying an electrical potential of reverse polarity(e.g., negative) between the front plane electrode 104 and the back plane electrode 106 would “write” all of the electrostatic display cells 102 (i.e., all of the cells would take on a second state). In other words, the front plane electrode 104 and the back plane electrode 106 are not arranged in a grid such that an electrical potential may be applied selectively at the desired resolution (e.g., hundreds of electrostatic display cells per inch).

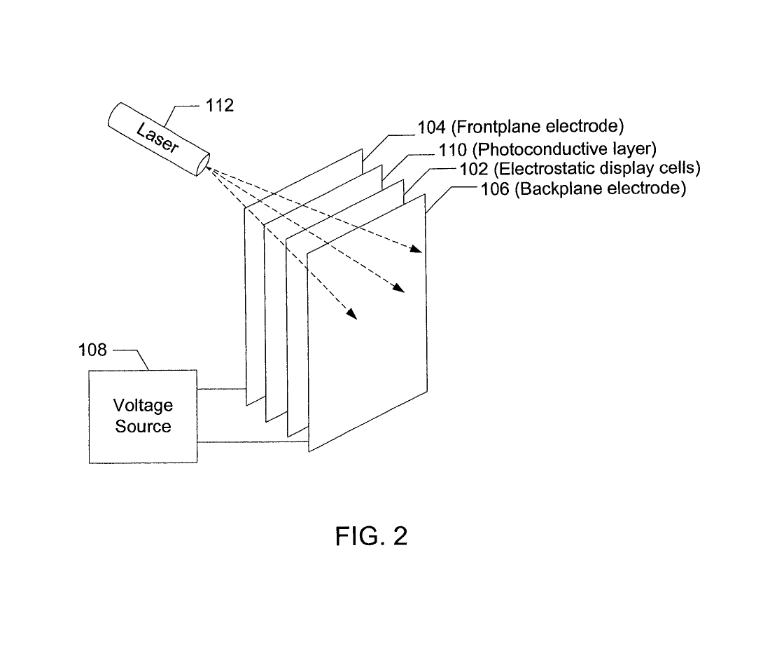

The photoconductive layer 110 is inserted between one of the electrode planes 104, 106 and the electrostatic display cells 102. In one embodiment, the photoconductive layer 110 is placed between the back plane electrode 106 and the electrostatic display cells 102. In a second embodiment, the photoconductive layer 110 is placed between the front plane electrode 104 and the electrostatic display cells 102 (see FIG. 2). In this second embodiment, the photoconductive layer 110 is preferably as nearly transparent to visible light as can be achieved, so that the visible image is attenuated as little as possible. One method to achieve this is to design or select a photoconductive layer 110 that is transparent to visible light, but is activated by light outside the visible spectrum. In this embodiment, the actinic light necessary to activate the photoconductive layer 110 is provided by a light source inside the imaging device.

The laser device 112 (or some other focused light source such as a light emitting diode array or a light emitting polymer array) provides the frequency of light appropriate for the photoconductive layer 110 only at the locations appropriate for the image. Alternatively, light may be delivered using a light modulator such as a liquid crystal device which modulates light from one or more light sources to apply the image to the electronic paper.

In an alternate embodiment, an existing document may be copied on to electronic paper using a light source and a lens focusing system to directly image the source document on to the photoconductive layer 110 in a manner similar to existing photocopy machines where a document is imaged on to a photoconductive layer. In such a photocopying device, the photoconductive layer (typically a photoconducting drum) goes through a toning process where an electrostatically charged toner is applied to the drum and transferred to the paper. In the present embodiment, the photoconductive layer 110 of the electronic paper directly achieves the imaging in the manner described herein. In the present embodiment, the imaging of the source document on to the photoconductive layer 110 may be achieved by several means. For example, an illuminated source document may be focused on to the electronic paper in its entirety by an appropriate lens system. In another example, a traveling mirror may progress across the source document and a strip section of the source document may be focused by a suitable lens system on to the corresponding section of the electronic paper. This method is analogous to similar methods used in platen based photocopiers. In yet another example, the image may be focused on to the electronic paper by an appropriate lens system, and the image transfer occurs when a light is flashed to illuminate the source document. This may be achieved as an entire image or by sections. Still further, in another example, the source document may be fed into the electronic imaging unit simultaneously with the electronic paper, and the image may be focused by a suitable lens system from a strip across the beginning of the source documents on to a strip at the beginning of the electronic paper. The focused section then progresses to the end of the source document and the end of the electronic copy.

In any of the embodiments described herein, in order to change selected electrostatic display cells 102 to a first state (e.g., black), a first electrical potential (e.g., positive) is applied between the front plane electrode 104 and the back plane electrode 106, and the light source 112 shines a coherent light on each of the selected locations for a period of time necessary to effect change in an electrostatic display cell. Similarly, in order to change selected electrostatic display cells 102 to a second state (e.g., white), a reverse electrical potential (e.g., negative) is applied between the front plane electrode 104 and the back plane electrode 106. While the electrical potential is present, the light source 112 illuminates each of the selected locations for a period of time necessary to effect change in an electrostatic display cell 102.

In order for light to reach the photoconductive layer 110, the front plane electrode 104 must be transparent to the spectral light frequency emitted by the light source 112. In addition, if the front plane electrode 104 remains attached to the electrostatic display cells 102 after imaging (e.g., the front plane electrode 104 is part of the “paper”), the front plane electrode 104 must be transparent to visible light to allow a person to view the electrostatic display cells 102. In an alternate embodiment, the front plane electrode 104, the back plane electrode 106, and/or the photoconductive layer 110 are part of the printing device and do not remain with the electrostatic display cells 102 after imaging. For example, a device similar to a conventional photocopier or laser printer may be used to image electrostatic paper. In such an instance, the electrostatic change on the drum which represents the image may be rolled against the electrostatic paper. The charge on the drum achieves the necessary changes to the electrostatic display cells 102. In such an instance, the front plane electrode 104 need not be transparent to the light frequency emitted by the light source 112.

In embodiments where the front plane electrode 104 and the back plane electrode 106 are part of the electronic paper, the back plane electrode 106 is preferably white in color to increase the contrast of the “printed” electrostatic display cells 102. In addition, the front plane electrode 104 and the back plane electrode 106 preferably include electrical contact points for the printing mechanism to supply an electrical potential. In one embodiment, the electronic paper may be double-sided. In such an instance, the back plane electrode 106 would preferably be the middle layer, and two front plane electrodes 104 (one on each side) are used.

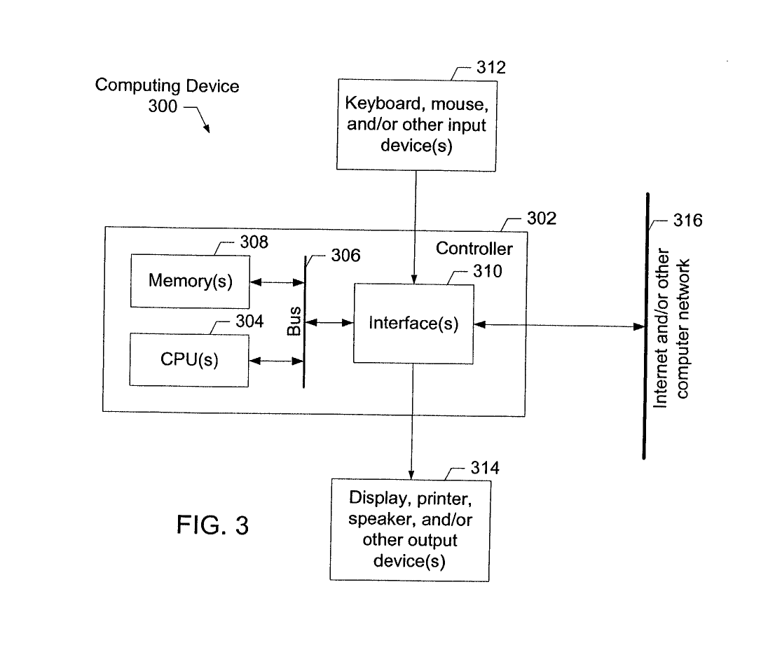

Preferably, the light source 112 is controlled by a computing device 300. A block diagram of an exemplary computing device 300 is illustrated in FIG. 3. The computing device 300 includes a controller 302 which preferably includes a central processing unit (CPU) 304 electrically coupled by an address/data bus 306 to a memory device 308 and an interface circuit 310. The CPU 304 may be any type of well known CPU, such as an Intel Pentium™ processor. The memory device 308 preferably includes volatile memory and non-volatile memory. Preferably, the memory device 308 stores a software program that interacts with the light source 112 as described below. This program may be executed by the CPU 304 in a well known manner.

The interface circuit 310 may be implemented using any type of well known interface standard, such as an Ethernet interface and/or a Universal Serial Bus (USB) interface. One or more input devices 312 may be connected to the interface circuit 310 for entering data and commands into the controller 302. For example, the input device 312 may be a keyboard, mouse, touch screen, track pad, track ball, isopoint, and/or a voice recognition system.

One or more displays or other output devices 314 may also be connected to the controller 302 via the interface circuit 310. The display 314 may be cathode ray tube (CRTs), liquid crystal displays (LCDs), or any other type of display. The display 314 generates visual displays of data generated during operation of the computing device 302. The visual displays may include prompts for human operator input, run time statistics, calculated values, detected data, etc.

The computing device 302 may also exchange data with other devices via a connection to a network 316. The network connection may be any type of network connection, such as an Ethernet connection, digital subscriber line (DSL), telephone line, coaxial cable, etc.

In summary, persons of ordinary skill in the art will readily appreciate that a method and apparatus for imaging electronic paper has been provided. Illuminating the electronic paper from the front with actinic light, while an electrical field is in one direction, erases an image. A new image may be written by selectively illuminating the electronic paper while the electrical field is in the other direction. A scanning laser beam may be used to achieve such illumination. This system allows an image to be “printed” without requiring an electrically addressed electrode pattern. Only one pair of electrodes (front plane and back plane) need to be addressed electrically. Addressing is effectively provided by positioning of the scanning laser beam.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of imaging electronic paper, the method comprising the steps of:
providing a focused light source structured to emit a light beam;
positioning a back plane electrode layer in front of the focused light source;
positioning a photoconductive layer between the back plane electrode layer and the focused light source;
positioning an electrostatic display cell layer between the photoconductive layer and the focused light source;
positioning a front plane electrode layer between the electrostatic display cell layer and the focused light source, the front plane electrode layer being transparent to the light beam;
generating an electrical potential between the front plane electrode layer and the back plane electrode layer; and
emitting the light beam from the focused light source while the electrical potential between the front plane electrode layer and the back plane electrode layer is being generated.

2. A method as defined in claim 1, further comprising the step of stepping the focused light source across the electronic paper.

3. A method as defined in claim 1, further comprising the step of stepping advancing the electronic paper line by line.

4. A method as defined in claim 1, wherein the step of providing a focused light source comprises the step of providing a laser device.

5. A method as defined in claim 1, wherein the step of providing a focused light source comprises the step of providing an invisible ray source.

6. A method as defined in claim 1, wherein the step of providing a focused light source comprises the step of providing a light source containing infrared light.

7. A method as defined in claim 1, wherein the step of providing a focused light source comprises the step of providing a light source containing ultraviolet light.

8. A method as defined in claim 1, wherein the step of positioning a back plane electrode layer comprises the step of positioning a white back plane electrode layer.

9. A method as defined in claim 1, wherein the step of positioning a photoconductive layer comprises the step of positioning a selenium layer.

10. A method as defined in claim 1, wherein the step of positioning a photoconductive layer comprises the step of positioning a layer of photoconductive silicon.

11. A method as defined in claim 1, wherein the step of positioning a photoconductive layer comprises the step of positioning a layer of cadmium sulfide.

12. A method as defined in claim 1, wherein the step of positioning a photoconductive layer comprises the step of positioning an organic photoconductor.

13. A method as defined in claim 1, wherein the step of positioning an electrostatic display cell layer comprises the step of positioning a layer of translucent enclosures, each translucent enclosure containing a fluid and an electrically charged material.

14. A method as defined in claim 1, wherein the step of positioning an electrostatic display cell layer comprises the step of positioning a layer of spheres, each sphere being captured in a translucent cell such that each sphere is freely rotatable within the translucent cell, each sphere having one color on the front of the sphere and another color on the back of the sphere, each sphere being electrostatically charged with a charge of one polarity on the front of the sphere and a charge of another polarity on the back of the sphere.

15. A method as defined in claim 1, wherein the step of positioning a front plane electrode layer comprises the step of positioning a front plane electrode layer which is transparent to visible light.

16. A method of imaging electronic paper, the method comprising the steps of:
providing a focused light source structured to emit a light beam;
positioning a back plane electrode layer in front of the focused light source;
positioning an electrostatic display cell layer between the back plane electrode layer and the focused light source;
positioning a photoconductive layer between the electrostatic display cell layer and the focused light source;
positioning a front plane electrode layer between the photoconductive layer and the focused light source, the front plane electrode layer being transparent to the light beam;
generating an electrical potential between the front plane electrode layer and the back plane electrode layer; and
emitting the light beam from the focused light source while the electrical potential between the front plane electrode layer and the back plane electrode layer is being generated.

17. A method as defined in claim 16, further comprising the step of stepping the focused light source across the electronic paper.

18. A method as defined in claim 16, further comprising the step of stepping advancing the electronic paper line by line.

19. A method as defined in claim 16, wherein the step of providing a focused light source comprises the step of providing a laser device.

20. A method as defined in claim 16, wherein the step of providing a focused light source comprises the step of providing an invisible ray source.

21. A method as defined in claim 16, wherein the step of providing a focused light source comprises the step of providing an infrared source.

22. A method as defined in claim 16, wherein the step of providing a focused light source comprises the step of providing an ultraviolet source.

23. A method as defined in claim 16, wherein the step of positioning a back plane electrode layer comprises the step of positioning a white back plane electrode layer.

24. A method as defined in claim 16, wherein the step of positioning a photoconductive layer comprises the step of positioning a selenium layer.

25. A method as defined in claim 16, wherein the step of positioning a photoconductive layer comprises the step of positioning a layer of photoconductive silicon.

26. A method as defined in claim 16, wherein the step of positioning a photoconductive layer comprises the step of positioning a layer of cadmium sulfide.

27. A method as defined in claim 16, wherein the step of positioning a photoconductive layer comprises the step of positioning an organic photoconductor.

28. A method as defined in claim 16, wherein the step of positioning an electrostatic display cell layer comprises the step of positioning a layer of translucent enclosures, each translucent enclosure containing a fluid and an electrically charged material.

29. A method as defined in claim 16, wherein the step of positioning an electrostatic display cell layer comprises the step of positioning a layer of spheres, each sphere being captured in a translucent cell such that each sphere is freely rotatable within the translucent cell, each sphere having one color on the front of the sphere and another color on the back of the sphere, each sphere being electrostatically charged with a charge of one polarity on the front of the sphere and a charge of another polarity on the back of the sphere.

30. A method as defined in claim 16, wherein the step of positioning a front plane electrode layer comprises the step of positioning a front plane electrode layer which is transparent to visible light.

31. An apparatus for imaging electronic paper, the apparatus comprising:
a switchable voltage source;
a front plane electrode electrically connected to the switchable voltage source;
a back plane electrode electrically connected to the switchable voltage source;
a focused light source positioned to emit a light on each of a plurality of selected locations of the front plane electrode; and
a controller operatively coupled to the switchable voltage source and the focused light source, the controller causing the switchable voltage source to produce an electrical potential between the front plane electrode layer and the back plane electrode layer, the controller causing the focused light source to emit the light beam from the focused light source while the electrical potential between the front plane electrode layer and the back plane electrode layer is being generated.

32. An apparatus as defined in claim 31, wherein the focused light source comprises a laser device.

33. An apparatus as defined in claim 31, wherein the focused light source comprises an infrared source.

34. An apparatus as defined in claim 31, wherein the focused light source comprises an ultraviolet source.

35. An apparatus as defined in claim 31, wherein the focused light source comprises a light emitting diode array

36. An apparatus as defined in claim 31, wherein the focused light source comprises a light emitting polymer array

37. An apparatus as defined in claim 31, wherein the focused light source comprises a modulated light source.

38. An apparatus as defined in claim 37, wherein the modulated light source comprises a liquid crystal display.
